(19) United States
(12) Patent Application Publication
(10) Pub. No.: US 2025/0248555 A1
(43) Pub. Date: Aug. 7, 2025

(54) SLOW COOKER

(71) Applicant: SHENZHEN YINGBOWEIYE TECHNOLOGY CO., LTD., Shenzhen (CN)

(72) Inventors: Jinghua XIE, Shenzhen (CN); Jingru XIE, Shenzhen (CN); Shanyou CHEN, Shenzhen (CN); Yong CAI, Shenzhen (CN)

(21) Appl. No.: 18/621,160

(22) Filed: Mar. 29, 2024

(30) Foreign Application Priority Data
Feb. 7, 2024 (CN) 202410175821.2

(51) Int. Cl. A47J 27/00

(52) U.S. Cl. CPC A47J 27/002; A47J 27/004

(57) ABSTRACT

Disclosed is a slow cooker, which comprises a cooker body, a cooker cover, an inner container, a heating component, a stirring component and a limiting component, the cooker cover is arranged on the cooker body, an assembly cavity is formed inside the cooker body, and the cooker cover comprises a perspective structure arranged opposite to the assembly cavity; the stirring component comprises a power assembly and a stirring member, the stirring member is arranged in an accommodating cavity, and the power assembly is used for driving the stirring member to rotate; and a limiting space is enclosed by the limiting component and the inner container for limiting a movement range of the stirring member.

### CROSS REFERENCE TO RELATED APPLICATIONS

The present application claims the benefit of Chinese Patent Application No. 202410175821.2 filed on Feb. 7, 2024, the contents of which are incorporated herein by reference in their entirety.

### TECHNICAL FIELD

The present invention relates to the technical field of kitchen electrical appliances, and particularly to a slow cooker.

### BACKGROUND

Slow cooker is a kind of kitchenware used to heat food slowly and evenly, which may keep the food full of moisture during cooking, thus making the food taste better.

According to existing slow cookers, a cooking state of food cannot be observed in real time during cooking, and a cooker cover needs to be opened to observe the cooking state of food, leading to a serious heat loss of a cooker body, so that an ideal cooking taste cannot be achieved within set time. Moreover, a magnetic stirring device is used in the existing slow cookers, and a fluid in the cooker is rotatably stirred by a magnetic member, so that the fluid may be heated evenly. However, because the magnetic member is located in the cooker and is in contact with the fluid, users are easy to take out the magnetic member by mistake when taking out the food in the cooker.

### SUMMARY

In order to solve at least one problem in the prior art, the present invention provides a slow cooker.

The slow cooker comprises: a body component, an inner container, a heating component, a stirring component and a limiting component, wherein the body component comprises a cooker body and a cooker cover, wherein the cooker cover is arranged on the cooker body, an assembly cavity is formed inside the cooker body, and the cooker cover comprises a perspective structure arranged opposite to the assembly cavity; the inner container is connected with the cooker body and located in the assembly cavity, wherein an accommodating cavity is formed inside the inner container; the heating component is arranged between the inner container and the cooker body, wherein the heating component is used for providing heat energy to the inner container; the stirring component comprises a power assembly and a stirring member, wherein the stirring member is arranged in the accommodating cavity, the power assembly and the stirring member are arranged on two opposite sides of the inner container at interval, and the power assembly is used for driving the stirring member to rotate; and the limiting component is connected to the inner container, a limiting space is enclosed by the limiting component and the inner container, the limiting component is provided with a water outlet hole communicated with the limiting space, the stirring member is arranged in the limiting space, and the limiting space is used for limiting a movement range of the stirring member.

In some embodiments, the heating component comprises a heating member and an elastic member, the heating member is attached to an outer side surface of the inner container, two ends of the elastic member are elastically connected with two ends of the heating member respectively, and the elastic member tightens the two ends of the heating member in a direction close to each other, so that the heating member is tightly attached to the outer side surface of the inner container.

In some embodiments, the heating component further comprises a fixing sheet, the fixing sheet is connected with the inner container, and the fixing sheet makes the heating member abut against the inner container.

In some embodiments, the cooker cover further comprises a cover body, a middle region of the cover body is provided with a mounting space, and the perspective structure is arranged in the mounting space; and the perspective structure comprises a perspective portion and a connecting portion which are connected with each other, the connecting portion is arranged at an edge of the perspective portion, the cover body is provided with a connecting groove, and the connecting portion is inserted into the connecting groove, wherein a thickness of the connecting portion is greater than that of the perspective portion, and the perspective portion and the cover body are arranged at interval.

In some embodiments, the cooker cover further comprises a handle, a buffering member and a fixing member, the perspective structure is provided with at least one fixing hole, the buffering member penetrates through the fixing hole and is connected with the perspective structure, the handle is connected with the buffering member, a through hole is formed inside the buffering member, and the fixing member penetrates through the through hole and is connected with the handle.

In some embodiments, the slow cooker further comprises a placing rack, the placing rack is selectively placed in the accommodating cavity, and the placing rack is provided with a plurality of placing grooves for placing food.

In some embodiments, the cooker body comprises an upper shell, a middle shell and a lower shell which are sequentially connected from top to bottom, the assembly cavity is enclosed by the upper shell, the middle shell and the lower shell jointly, an edge of an opening end of the inner container is bent outwardly to form a bending portion, and the bending portion is connected with the upper shell.

In some embodiments, the slow cooker further comprises a circuit component, the cooker body comprises a lower shell located at a bottom portion of the cooker body and a cover plate detachably connected with the lower shell, at least a part of an outer surface of the lower shell protrudes in a direction close to the inner container to form a convex portion, a mounting groove is formed inside the convex portion, the circuit component is arranged in the mounting groove and the circuit component and the convex portion are arranged at interval, the mounting groove is open towards the outside of the cooker body, and the cover plate is covered at an opening end of the mounting groove.

In some embodiments, the cooker body further comprises a reinforcing structure, the reinforcing structure is annularly arranged on an inner side surface of the lower shell, and the reinforcing structure comprises an outer layer, a reinforcing rib and an inner layer in a direction from an edge of the lower shell to a center of the lower shell, and the reinforcing ribs are respectively connected with the outer layer and the inner layer.

In some embodiments, the slow cooker further comprises a heat preservation sheet, and two opposite sides of the heat preservation sheet respectively abut against an inner side surface of the body component and an outer side surface of the inner container.

Compared with the prior art, the slow cooker in the embodiment of the present invention has the beneficial effects as follows: the present application comprises the cooker body, the cooker cover, the inner container, the heating component, the stirring component and the limiting component, the cooker cover is arranged on the cooker body, the assembly cavity is formed inside the cooker body, and the cooker cover comprises the perspective structure arranged opposite to the assembly cavity; the heating component is arranged between the inner container and the cooker body, and the heating component is used for providing heat energy to the inner container; the stirring component comprises the power assembly and the stirring member, the stirring member is arranged in the accommodating cavity, and the power assembly is used for driving the stirring member to rotate; and the limiting space is enclosed by the limiting component and the inner container, the stirring member is arranged in the limiting space, and the limiting space is used for limiting the movement range of the stirring member. Compared with the prior art, the application is provided with the perspective structure and the limiting component, so that a user can directly observe a cooking state of food in the accommodating cavity through the perspective structure to determine whether it is necessary to stir the food or add spices, thus improving the use convenience of the device and achieving a better cooking effect; and the limiting space limits the stirring member, and the movement range of the stirring member is only limited in the limiting space, so that the stirring member is avoided from being taken out when the food is taken out, thus solving the problem that it is difficult to separate the stirring member and the food which are mixed.

### BRIEF DESCRIPTION OF THE DRAWINGS

FIG. 1 is a schematic structural diagram of a slow cooker in an embodiment of the present application;

FIG. 2 is an exploded view of parts of the slow cooker in the embodiment of the present application;

FIG. 3 is a schematic structural diagram of a cooker body in the embodiment of the present application;

FIG. 4 is a locally enlarged view of the slow cooker in the embodiment of the present application;

FIG. 5 is another exploded view of the parts of the slow cooker in the embodiment of the present application;

FIG. 6 is an enlarged view of a structure at a part A in FIG. 5;

FIG. 7 is an exploded view of parts of a cooker cover in the embodiment of the present application;

FIG. 8 is a cross-sectional view of the cooker cover in the embodiment of the present application;

FIG. 9 is an enlarged view of a structure at a part D in FIG. 8;

FIG. 10 is an enlarged view of a structure at a part E in FIG. 8;

FIG. 11 is a schematic structural diagram of a placing rack in the embodiment of the present application;

FIG. 12 is a cross-sectional view of the slow cooker in the embodiment of the present application;

FIG. 13 is an enlarged view of a structure at a part F in FIG. 12;

FIG. 14 is another cross-sectional view of the slow cooker in the embodiment of the present application;

FIG. 15 is an enlarged view of a structure at a part B in FIG. 14;

FIG. 16 is an exploded view of parts of a cooker body in the embodiment of the present application;

FIG. 17 is an enlarged view of a structure at a part C in FIG. 16; and

FIG. 18 is an enlarged view of a structure at a part G in FIG. 16.

Reference numerals: 1 refers to body component; 11 refers to cooker body; and 12 refers to cooker cover;
111 refers to upper shell; 112 refers to middle shell; 113 refers to lower shell; 114 refers to cover plate; 115 refers to reinforcing structure; 116 refers to line clamping portion; 121 refers to cover body; 122 refers to perspective structure; 123 refers to handle; 124 refers to buffering member; and 125 refers to fixing member;
1111 refers to step portion; 1112 refers to clamping groove; 1131 refers to convex portion; 1132 refers to mounting groove; 1133 refers to boss; 1134 refers to fixing seat; S1 refers to assembly cavity; 1211 refers to connecting groove; 1212 refers to first housing; 1213 refers to second housing; 1214 refers to mounting space; 1215 refers to sealing member; 1221 refers to perspective department; 1222 refers to connecting portion; 1223 refers to fixing hole; 1151 refers to outer layer; 1152 refers to reinforcing rib; and 1153 refers to inner layer;
2 refers to inner container; S2 refers to accommodating cavity; and 21 refers to bending portion;
3 refers to heating component; 31 refers to heating member; 32 refers to elastic member; 33 refers to fixing sheet; 311 refers to hook hole; 312 refers to heat generation sheet; 313 refers to protective frame; 314 refers to curled structure; 321 refers to claw; 331 refers to fixing portion; and 332 refers to abutting portion;
4 refers to stirring component; 41 refers to power assembly; 42 refers to stirring member; 411 refers to driving member; and 412 refers to magnetic member;
5 refers to limiting component; 51 refers to limiting space; and 52 refers to water outlet hole;
6 refers to placing rack; 61 refers to placing groove; 62 refers to first rack body; 63 refers to second rack body; 64 refers to third rack body; 7 refers to circuit component; 8 refers to heat preservation sheet; and 9 refers to power cord.

### DETAILED DESCRIPTION

In order to make those skilled in the art better understand the technical solution of the present invention, the present invention is described in detail hereinafter with reference to the drawings, and the descriptions in this part are only exemplary and explanatory, and should not limit the scope of protection of the present invention.

It should be noted that: similar reference numerals and letters indicate similar items in the following drawings, so once one item is defined in one drawing, it does not need to be further defined and explained in the following drawings.

It should be noted that if the orientation or position relationship indicated by the terms “center”, “upper”, “lower”, “left”, “right”, “vertical”, “horizontal”, “inner”, “outer”, and the like is based on the orientation or position relationship shown in the accompanying drawings, or the orientation or position relationship of the product of the present invention in use, it is only for the convenience of description of the present invention and simplification of the description, and it is not to indicate or imply that the indicated device or element must have a specific orientation, and be constructed and operated in a specific orientation. Therefore, the terms should not be understood as limiting the present invention. In addition, the terms “first”, “second”, “third”, and the like are used for distinguishing description only and cannot be understood as indicating or implying relative importance.

In addition, the terms “horizontal”, “vertical”, “overhanging”, and the like do not mean that the components are required to be absolutely horizontal or overhanging, but may be slightly inclined. For example, “horizontal” only means that the direction is more horizontal relative to “vertical”, and does not mean that the structure must be completely horizontal, but may be slightly inclined.

Unless otherwise defined, all technical and scientific terms used herein have the same meanings as those commonly understood by those skilled in the technical field of the present invention. The terms used in the specification of the present invention herein are only for the purpose of describing specific embodiments, and are not intended to limit the present invention.

The present invention is further described in detail hereinafter with reference to the drawings.

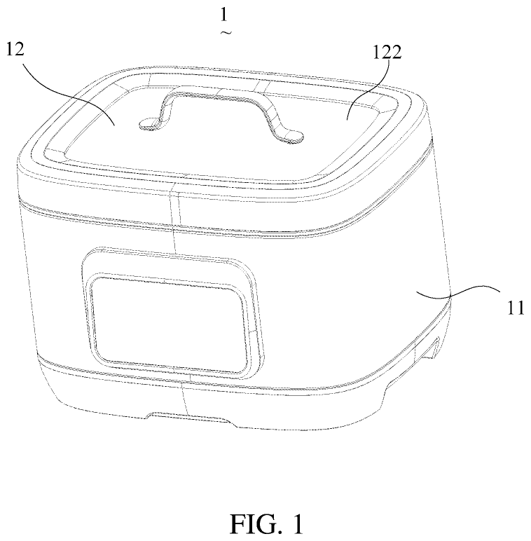

With reference to FIG. 1, a slow cooker comprises a cooker body 11, a cooker cover 12 and an inner container 2. The cooker cover 12 is arranged on the cooker body 11, an assembly cavity S1 is formed inside the cooker body 11, and the cooker cover 12 comprises a perspective structure 122 arranged opposite to the assembly cavity S1. The inner container 2 is connected with the cooker body 11 and located in the assembly cavity S1, an accommodating cavity S2 is formed inside the inner container 2, and the accommodating cavity S2 is used for placing food. It should be noted that the perspective structure 122 is a transparent component that allows light to penetrate through without changing an emission direction of the light, and the perspective structure 122 may be made of inorganic glass or an acrylic structure, thus having an excellent optical performance.

It should be noted that the inner container 2 and the cooker body 11 may be connected in various ways, such as welding, screwing, clamping or overlapping.

The perspective structure 122 is arranged on the cooker cover 12, and the perspective structure 122 is opposite to the assembly cavity S1, so that the perspective structure 122 is also arranged opposite to the accommodating cavity S2. Therefore, a user may directly observe a cooking state of food in the accommodating cavity S2 through the perspective structure 122 during cooking to determine whether it is necessary to stir the food or add spices, thus improving the use convenience of the device and achieving a better cooking effect

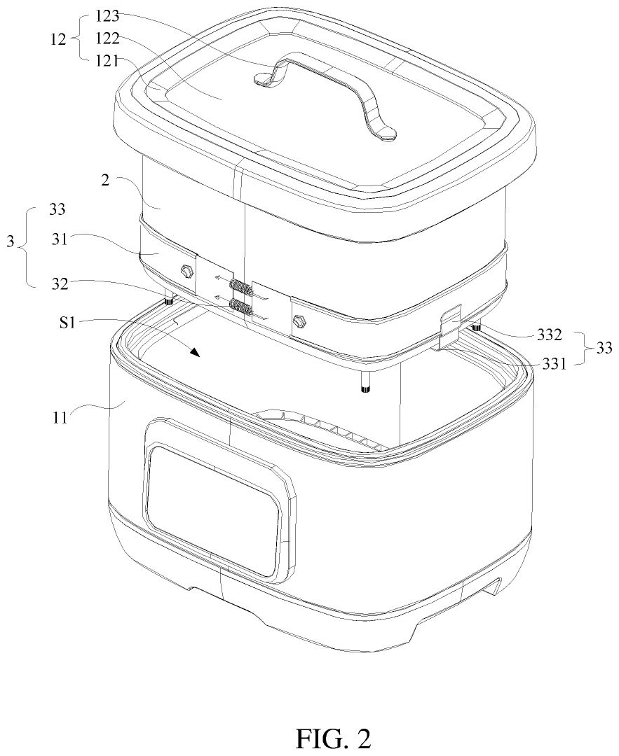

With reference to FIG. 2, the slow cooker above further comprises a heating component 3, a stirring component 4 and a limiting component 5, the heating component 3 is arranged between the inner container 2 and the cooker body 11, and the heating component 3 is used for providing heat energy to the inner container 2. The stirring component 4 comprises a power assembly 41 and a stirring member 42, wherein the stirring member 42 is arranged in the accommodating cavity S2, the power assembly 41 and the stirring member 42 are arranged on two opposite sides of the inner container 2 at interval, and the power assembly 41 is used for driving the stirring member 42 to rotate.

In practical application, food is placed in the accommodating cavity S2 of the inner container 2, and then a liquid is added into the accommodating cavity S2. The heating component 3 may be attached to the inner container 2, the heating component 3 heats the inner container 2 by a heat generation function of the heating component 3, the inner container 2 transfers heat to the internal liquid, and the heated liquid continuously heats the food. Meanwhile, the power assembly 41 drives the stirring member 42 in the accommodating cavity S2 to rotate, so as to stir the liquid, thus driving the liquid to be heated evenly in the inner container 2, so that heating temperatures on various parts of the food are the same, which avoids the situation that a bottom portion of the food is heated at a high temperature and a top portion of the food is heated at a low temperature.

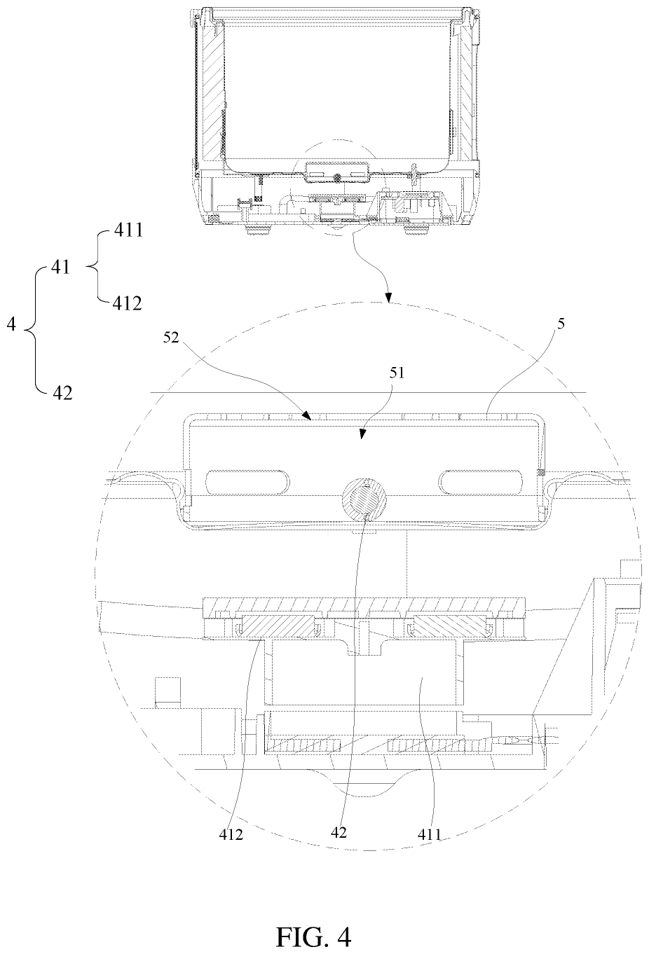

In one embodiment, the stirring component 4 adopts magnetic stirring. Specifically, with reference to FIG. 4, the stirring member 42 is a magnet. The power assembly 41 may comprise a driving member 411 and a magnetic member 412, the driving member 411 may be a motor, and the magnetic member 412 may also be a magnet. The motor (the driving member 411) is connected with the magnetic member 412 and drives the magnetic member 412 to rotate, a magnetic field is generated under the movement of that magnetic member 412, and the stirring member 42 (the magnet) rotates under an action of the magnetic field to realize a stirring function. In other embodiments, the driving member 411 may also be the motor, and the magnetic member 412 may be a conductive iron bar, an electromagnetic relay, and the like.

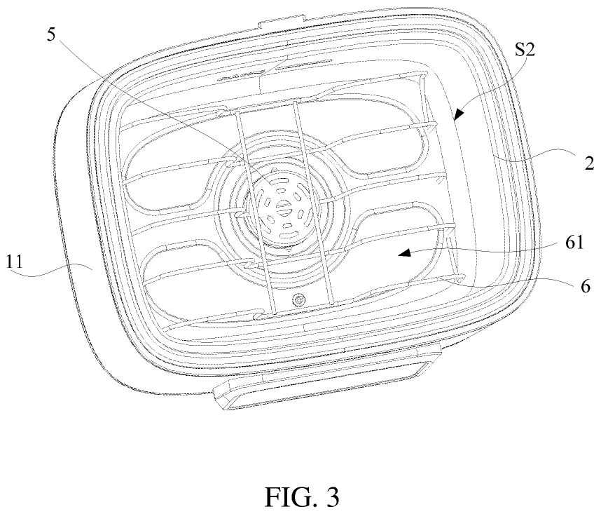

With reference to FIG. 3 and FIG. 4, the limiting component 5 above is connected to the inner container 2, a limiting space 51 is enclosed by the limiting component 5 and the inner container 2, the limiting component 5 is provided with a water outlet hole 52 communicated with the limiting space 51, the stirring member 42 is arranged in the limiting space 51, and the limiting space 51 is used for limiting a movement range of the stirring member 42.

In order to solve the problem that it is difficult to separate the stirring member 42 and the food which are mixed, the present application is provided with the limiting component 5, the limiting space 51 is enclosed by the limiting component 5 and the inner container 2, the limiting space 51 limits the stirring member 42, and the movement range of the stirring member 42 is only limited in the limiting space 51, so that the stirring member 42 is avoided from being taken out when the food is taken out. The limiting member 5 is provided with the water outlet hole 52, so that the stirring member 42 may be mixed with the liquid inside the inner container 2, which is convenient for the stirring member 42 to stir the liquid.

In one embodiment, the limiting component 5 may be a cover structure covered above the stirring member 42, and the limiting component 5 may be detachably connected with the inner container 2. After the cooking is finished, the limiting component 5 may be disassembled, and the stirring member 42 is taken out for cleaning, thus avoiding the stirring member 42 from being contaminated by food residues to affect the next cooking.

Compared with the prior art, the present application is provided with the perspective structure 122 and the limiting component 5, so that a user can directly observe a cooking state of food in the accommodating cavity S2 through the perspective structure 122 to determine whether it is necessary to stir the food or add spices, thus improving the use convenience of the device and achieving a better cooking effect; and the limiting space 51 limits the stirring member 42, and the movement range of the stirring member 42 is only limited in the limiting space 51, so that the stirring member 42 is avoided from being taken out when the food is taken out, thus solving the problem that it is difficult to separate the stirring member 42 and the food which are mixed.

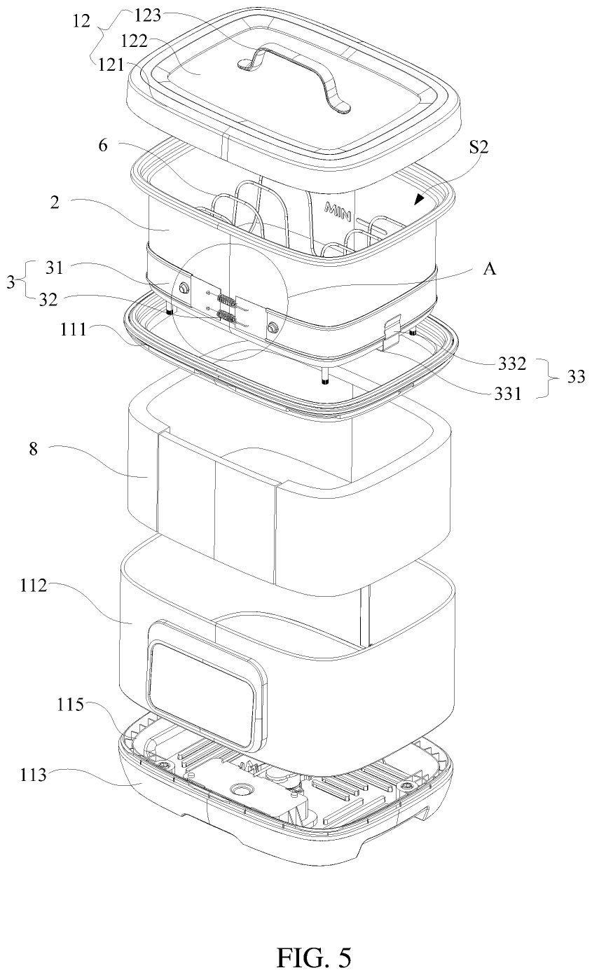

With reference to FIG. 5, the heating component 3 comprises a heating member 31 and an elastic member 32, the heating member 31 is attached to an outer side surface of the inner container 2, two ends of the elastic member 32 are elastically connected with two ends of the heating member 31 respectively, and the elastic member 32 tightens the two ends of the heating member 31 in a direction close to each other, so that the heating member 31 is tightly attached to the outer side surface of the inner container 2.

In one embodiment, the heating member 31 is strip-shaped, and the heating member 31 is preferably annularly attached to the outer side surface of the inner container 2, and may be closely attached to the inner container 2 by pressing, abutting, and other ways, so that the heating member 31 can transfer heat to the inner container 2 with maximum efficiency. The two ends of the elastic member 32 are respectively connected with the two ends of the heating member 31, the two ends of the heating member 31 are tightened in a direction close to each other, and the elastic member 32 continuously exerts a pulling force on the two ends of the heating member 31, so that the heating member can always be closely attached to the outer side surface of the inner container 2. The elastic member 32 may be a spring and other components.

The heating member 31 is annularly arranged on the outer side surface of the inner container 2, so that the heating member 31 may simultaneously heat the inner container 2 from a peripheral side of the inner container 2, thus greatly improving the uniformity and stability of heating. The elastic member 32 is elastically connected to the two ends of the heating member 31, so that the heating member 31 can always be attached to the inner container 2. Specifically, the heating member 31 is usually made of metal, and the metal may show cold shrinkage and thermal expansion in temperature changes, so that the heating member 31 is extended with the increase of temperature during heating. At this time, if the two ends of the heating member 31 are fixed, a middle portion of the heating member 31 is bent due to the cold shrinkage and thermal expansion. Therefore, a gap is formed between the heating member 31 and the inner container 2, which affects the efficiency of heat transfer. Under an elastic action of the elastic member 32, when the heating member 31 is extended during heating, the elastic member 32 draws the two ends of the heating member 31 closer through shrinkage, which ensures that the heating member 31 is always attached to the outer side surface of the inner container 2 during heating, thus realizing a function of even heating.

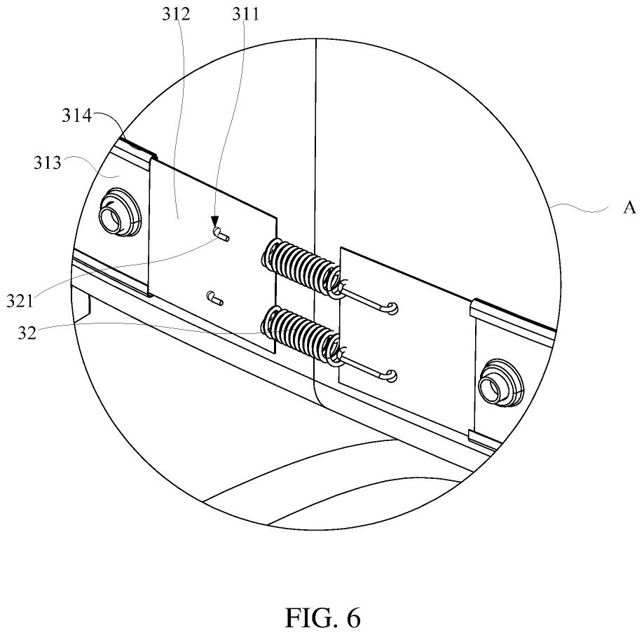

With reference to FIG. 6, in one embodiment, the elastic member 32 and the heating member 31 are connected in the following way: the two ends of the heating member 31 are provided with hook holes 311, the two ends of the elastic member 32 are provided with claws 321, and the hook holes 311 are hooked by the claws 321, so that the elastic member 32 is connected to the two ends of the heating member 31 respectively, which makes the mounting and replacement of the elastic member 32 more convenient.

With reference to FIG. 5, in one embodiment, the heating component 3 further comprises a fixing sheet 33, the fixing sheet 33 is connected with the inner container 2, and the fixing sheet 33 makes the heating member 31 abut against the inner container 2. The fixing sheet 33 is used to improve the stability of attachment between the heating member 31 and the inner container 2, thus further preventing the heating member 31 from generating a gap with or being separated from the inner container 2. The fixing sheet 33 may be fixed on the inner container 2 by welding, clamping, screwing, and other ways, and a plurality of fixing sheets 33 may be annularly arranged on the inner container 2 at interval to abut against the heating member 31 from multiple angles.

Specifically, the fixing sheet 33 comprises a fixing portion 331 and an abutting portion 332, the fixing portion 331 is fixed on a bottom surface of the inner container 2, the abutting portion 332 is connected with the fixing portion 331 and extends along the outside of the inner container 2, and the abutting portion 332 elastically abuts against the heating member 31. In practical application, the abutting portion 332 is a part of the fixing sheet 33 used for being in contact with and abutting against the heating member 31, the fixing portion 331 is a part of the fixing sheet 33 used for being fixed on the inner container 2, and the abutting portion 332 has an elastic force towards the heating member 31 to tightly press the heating member 31. The abutting portion 332 may be wave-shaped to increase the elastic force of the abutting portion 332, and meanwhile, a contact surface between the abutting portion 332 and the heating member 31 may be a smooth cambered surface to prevent causing a damage to the outside of the heating member 31 during pressing and abutting, and the wave-shaped structure can also play a guiding role during the assembly of the inner container 2, which is convenient for assembly.

In one embodiment, with reference to FIG. 6, the heating member 31 comprises a heat generation sheet 312 and a protective frame 313, the protective frame 313 surrounds the inner container 2 and is connected with the inner container 2, the heat generation sheet 312 is arranged on one side of the protective frame 313 close to the inner container 2, and two ends of the elastic member 32 are connected with two ends of the heat generation sheet 312 respectively, wherein an outermost frame structure of the heating component 3 outside the protective frame 313 is used to protect the heat generation sheet 312 inside the structure. The heat generation sheet 312 is a metal sheet for converting electric energy into heat energy, the heat generation sheet 312 is movably arranged inside the protective frame 313, and the elastic member 32 connects two ends of the heat generation sheet 312, so that the heat generation sheet may always maintain a tightened and attached state. The heat generation sheet 312 is easy to be damaged because a physical property of the heat generation sheet may be softened when the heat generation sheet is heated, and the protective frame 313 may protect and limit the heat generation sheet 312.

Specifically, an edge of the protective frame 313 is curled towards one side where the heat generation sheet 312 is located to form a curled structure 314, and the curled structure 314 wraps the edge of the heat generation sheet 312. Because the heat generation sheet 312 is often thin, the edge is easy to be damaged, the curled structure 314 may wrap the edge of the heat generation sheet 312 to protect the edge of the heat generation sheet 312, and the curled structure 314 may form a notch-like structure for the heat generation sheet 312, which may limit a position of the heat generation sheet 312 inside the protective frame 313, thus avoiding the heat generation sheet 312 from falling off.

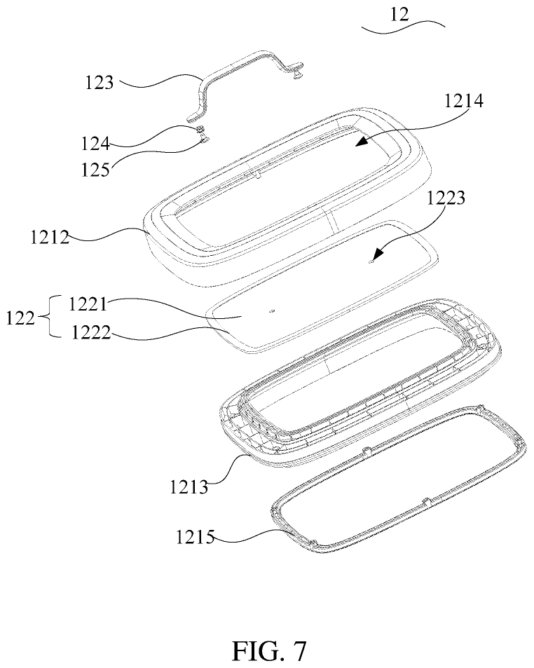

With reference to FIG. 7, the cooker cover 12 further comprises a cover body 121, a middle region of the cover body 121 is provided with a mounting space 1214, and the perspective structure 122 is arranged in the mounting space 1214. The perspective structure 122 comprises a perspective portion 1221 and a connecting portion 1222 which are connected with each other, the connecting portion 1222 is arranged at an edge of the perspective portion 1221, the cover body 121 is provided with a connecting groove 1211, and the connecting portion 1222 is inserted into the connecting groove 1211, wherein a thickness of the connecting portion 1222 is greater than that of the perspective portion 1221, and the perspective portion 1221 and the cover body 121 are arranged at interval.

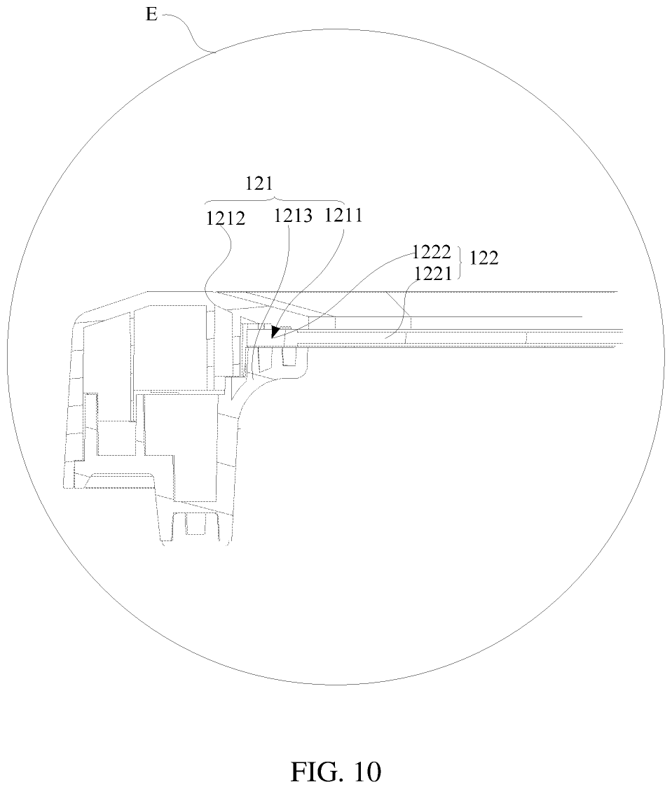

In one embodiment, the cover body 121 comprises a first housing 1212 and a second housing 1213 which are arranged up and down, the first housing 1212 and the second housing 1213 are detachably connected together, after the first housing 1212 and the second housing 1213 are connected together, a connecting groove 1211 surrounds edges of the first housing and the second housing, a hollow region between the first housing 1212 and the second housing 1213 is a mounting space 1214, the connecting groove 1211 is arranged around the mounting space 1214 and communicated with the mounting space 1214, and the mounting space 1214 is used for mounting a light-transmitting structure. Specifically, with reference to FIG. 10, the light-transmitting structure comprises a connecting portion 1222 and a perspective portion 1221, the connecting portion 1222 is annularly arranged on a periphery of the perspective portion 1221, and the connecting portion 1222 is inserted or clamped in the connecting groove 1211. Meanwhile, the perspective portion 1221 is located in the mounting space 1214, the first housing 1212 and the second housing 1213 are respectively clamped at a top portion and a bottom portion of the connecting portion 1222 from two opposite sides, and because a thickness of the connecting portion 1222 is greater than that of the perspective portion 1221, the perspective portion 1221 is separated from the first housing 1212 and the second housing 1213, which can effectively avoid vibration or thermal deformation generated by the first housing 1212 and the second housing 1213 from being transmitted to the perspective portion 1221, thus preventing the perspective portion 1221 from being broken.

The perspective portion 1221 is a transparent component that allows light to penetrate through without changing an emission direction of the light, and the perspective portion 1221 may be made of inorganic glass or an acrylic structure, thus having an excellent optical performance. The first housing 1212 and the second housing 1213 may be made of plastic or aluminum alloy, thus being cheap in material, excellent in mechanical property and light in weight.

It can be understood that the cover body further comprises a sealing member 1215, and the sealing member 1215 is connected with the second housing 1213. When the cooker cover 12 is arranged on the cooker body 11, the sealing member 1215 plays a sealing role to seal a gap at a joint between the cooker cover 12 and the cooker body 11, thus preventing heat loss.

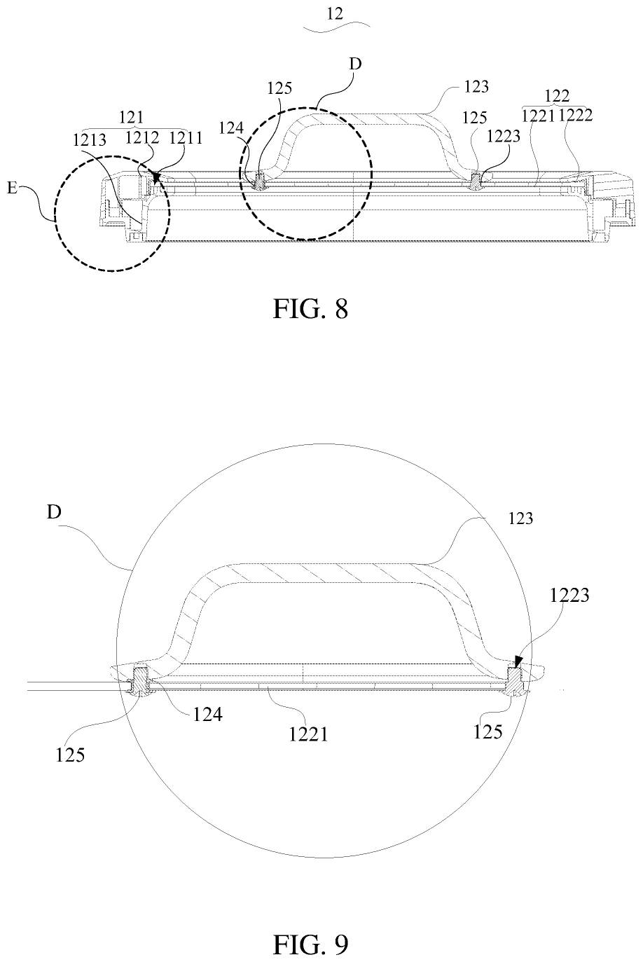

With reference to FIG. 8 and FIG. 9, the cooker cover 12 further comprises a handle 123, a buffering member 124 and a fixing member 125, the perspective structure 122 is provided with at least one fixing hole 1223, the buffering member 124 penetrates through the fixing hole 1223 and is connected with the perspective structure 122, the handle 123 is connected with the buffering member 124, a through hole is formed inside the buffering member 124, and the fixing member 125 penetrates through the through hole and is connected with the handle 123.

In order to facilitate the user to take and put the cooker cover 12, the present application is provided with the handle 123, the perspective portion 1221 is provided with at least one fixing hole 1223, the buffering member 124 penetrates through the fixing hole 1223, two ends of the buffering member 124 respectively abut against two side surfaces of the perspective portion 1221, and the fixing member 125 penetrates through the buffering member 124 and is connected with the handle 123, so that the handle 123 and the perspective portion 1221 are fixed together. The handle 123 is in non-contact connection with the perspective portion 1221 by arranging the buffering member 124, which effectively reduces an influence of the handle 123 on the perspective portion 1221 when the handle is subjected to an external force. When the user holds the handle 123, the vibration on the handle 123 mainly affects the fixing member 125 and the buffering member 124, and has little influence on the perspective portion 1221, thus ensuring the shape consistency of various parts of the perspective portion 1221 and ensuring the authenticity of a displayed image. The buffering member 124 may be an I-shaped nut, an embedded nut and the like, and the fixing member 125 may be a bolt, a screw and the like.

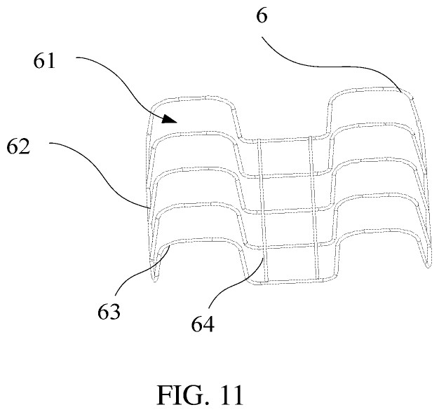

With reference to FIG. 11, the slow cooker further comprises a placing rack 6, the placing rack 6 is selectively placed in the accommodating cavity S2, and the placing rack 6 is provided with a plurality of placing grooves 61 for placing food. In practical application, the user chooses to use the placing rack 6 as required. For example, when food such as meat and a seasoning packet needs to be heated, the placing rack 6 may be placed in the accommodating cavity S2 to fix the food, which avoids the food from shaking in the inner container 2, thus being easy to cause damage to an outer packaging bag of the food.

In one embodiment, the placing rack 6 comprises a first rack body 62, a second rack body 63 and a third rack body 64, wherein the first rack body 62 forms an annular frame structure, a plurality of second rack bodies 63 are arranged at interval along a width direction of the annular frame structure, the second rack bodies 63 are in a wave shape, and the third rack body 64 is connected to wave troughs of the second rack bodies 63.

The first rack body 62 is arranged at an outermost periphery as a supporting frame of the placing rack 6, the plurality of second rack bodies 63 are arranged at interval in a region enclosed by the first rack body 62, the placing grooves 61 may be formed between the first rack body 62 and the second rack bodies 63 and between adjacent second rack bodies 63, and the food such as the meat and the seasoning packet is inserted into the placing grooves 61, so that the food may be quickly taken out from the placing grooves 61 after being heated. The third rack body 64 improves the connection stability between the first rack body 62 and the second rack bodies 63, which is beneficial for improving an overall structural strength of the placing rack 6, and making the placing rack more stable when placed in the inner container 2.

It can be understood that, in other embodiments, the placing rack 6 may also be arranged in other ways, for example, a mesh structure may be adopted, and each mesh forms the placing groove 61, which will not be limited in the present application.

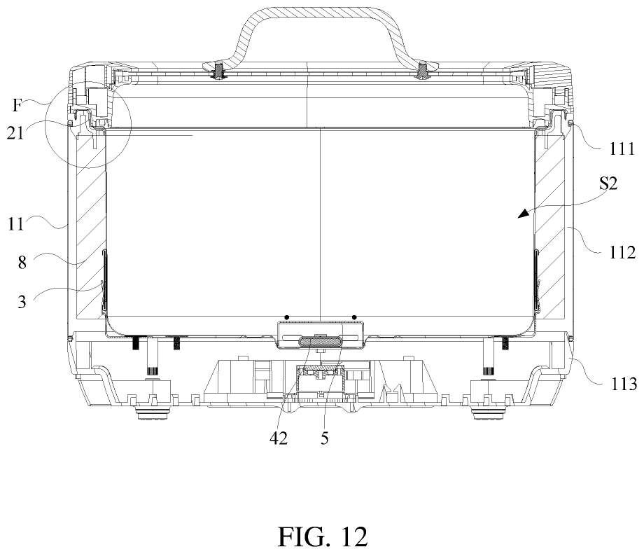

With reference to FIG. 12, the cooker body 11 comprises an upper shell 111, a middle shell 112 and a lower shell 113 which are sequentially connected from top to bottom, the assembly cavity S1 is enclosed by the upper shell 111, the middle shell 112 and the lower shell 113 jointly, and the three-layer structure of the upper shell 111, the middle shell 112 and the lower shell 113 can facilitate the assembly of the body component 1 and other components during production.

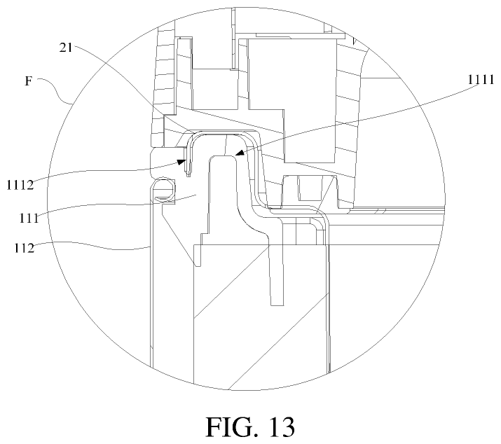

With reference to FIG. 13, an edge of an opening end of the inner container 2 is bent outwardly to form a bending portion 21, and the bending portion 21 is connected with the upper shell 111. Specifically, a step portion 1111 is formed at a top portion of the upper shell 111, and the edge part of the opening of the inner container 2 is matched with the step portion 1111, so that the opening end of the inner container 2 is overlapped on the step portion 1111, and the step portion 1111 may play limiting and guiding roles during assembly of the inner container 2. The step portion 1111 is a step-like part at an edge of the upper shell 111.

In order to further improve the connection between the inner container 2 and the upper shell 111, in one embodiment, a top portion of the upper shell 111 is circumferentially provided with an annular clamping groove 1112, and the edge of the opening of the inner container 2 is inserted into the clamping groove 1112, which plays a role of fixing the inner container 2 on one hand, and hermetically connects the inner container 2 with the cooker body 11 on the other hand, thus reducing heat loss and improving heating efficiency.

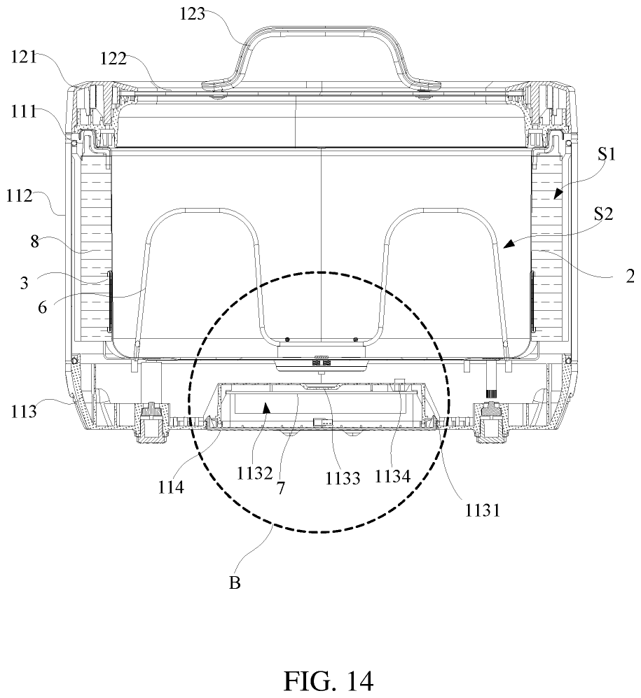

With reference to FIG. 14, the slow cooker further comprises a circuit component 7, the cooker body 11 comprises a lower shell 113 located at a bottom portion of the cooker body and a cover plate 114 detachably connected with the lower shell 113, at least a part of an outer surface of the lower shell 113 protrudes in a direction close to the inner container 2 to form a convex portion 1131, a mounting groove 1132 is formed inside the convex portion 1131, the circuit component 7 is arranged in the mounting groove 1132 and the circuit component and the convex portion 1131 are arranged at interval, the mounting groove 1132 is open towards the outside of the cooker body 11, and the cover plate 114 is covered at an opening end of the mounting groove 1132.

In practical application, the convex portion 1131 extends in the direction close to the inner container 2, which saves a design space and makes a bottom surface of the lower shell 113 flat to facilitate placing at the same time. The mounting groove 1132 is formed inside the convex portion 1131, and the mounting groove 1132 is open towards the outside of the cooker body 11. Specifically, the mounting groove may be open towards a direction far away from the inner container 2, which refers to being open towards the bottom surface of the lower shell 113. The cover plate 114 is covered at the opening end of the mounting groove 1132 and detachably connected with the lower shell 113, so that when the circuit component 7 is maintained, the circuit board may be exposed by detaching the cover plate 114, which is convenient for maintenance.

It can be understood that the cover plate 114 and the lower shell 113 may be detachably connected by a bolt, a screw and the like. The mounting groove 1132 may also be open towards a side surface of the lower shell 113, so that the slow cooker does not need to be turned over during maintenance.

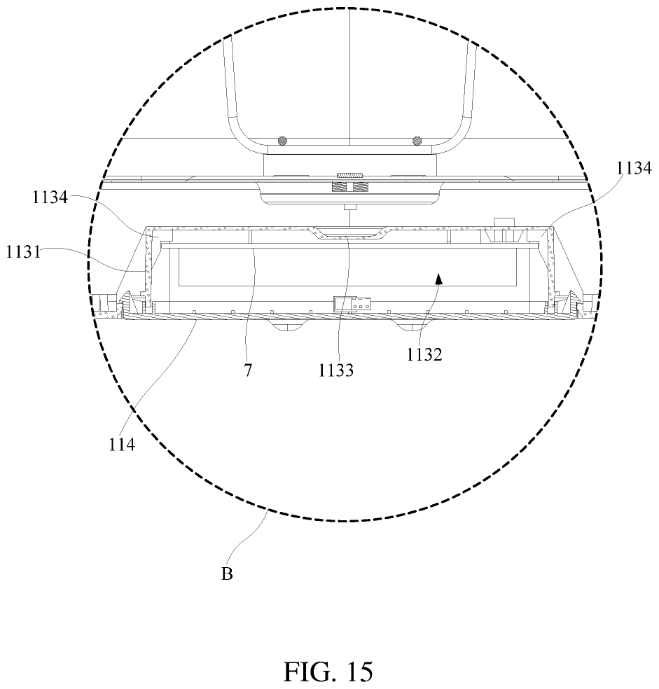

With reference to FIG. 15, in one embodiment, because there are many contacts on a back surface of the circuit component 7, and in order to avoid the circuit component 7 from being affected by the temperature of the inner container 2 at the same time, the circuit component 7 and the convex portion 1131 are arranged at interval. One side of a bottom plate of the convex portion 1131 oriented to the circuit component 7 is provided with a plurality of fixing seats 1134, the circuit component 7 is overlapped on the fixing seats 1134, and the circuit component 7 is separated from the convex portion 1131 by the fixing seats 1134, which can effectively reduce and hinder heat transfer to the circuit component 7.

More specifically, at least a part of the bottom plate of the convex portion 1131 protrudes in a direction close to the circuit component 7 to form a boss 1133, and the boss 1133 may also support the circuit component 7 when the circuit component 7 is slightly bent, so as to prevent the circuit component 7 from being excessively bent to cause the failure or even breakage of the circuit component 7. When the circuit component 7 is mounted, the boss 1133 may also support the circuit component 7 at a certain height, which is convenient for determining a fixed position of the circuit component 7, thus facilitating the mounting and positioning of the circuit component 7.

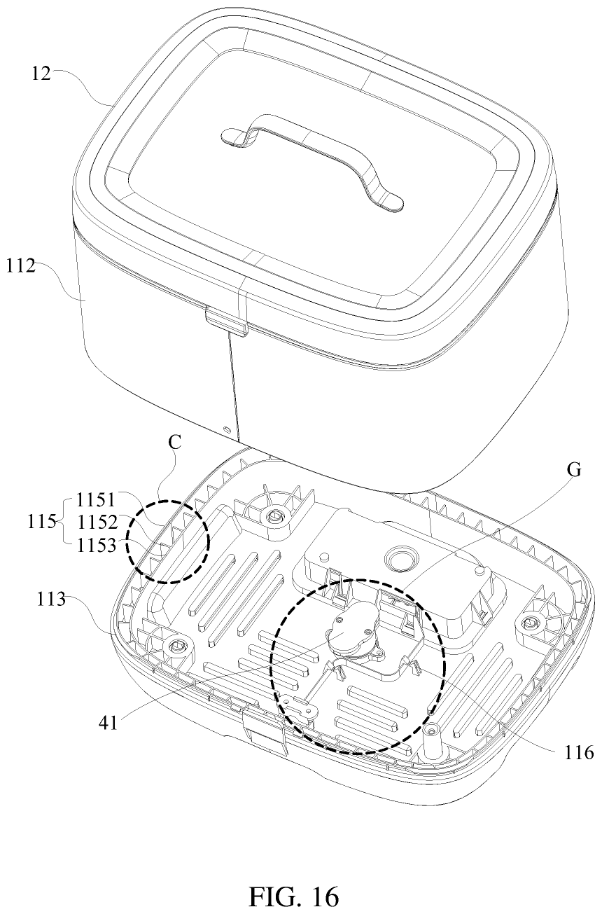

With reference to FIG. 16, the cooker body 11 further comprises a reinforcing structure 115, the reinforcing structure 115 is annularly arranged on an inner side surface of the lower shell 113, and the reinforcing structure 115 comprises an outer layer 1151, a reinforcing rib 1152 and an inner layer 1153 in a direction from an edge of the lower shell 113 to a center of the lower shell, and the reinforcing ribs 1152 are respectively connected with the outer layer 1151 and the inner layer 1153.

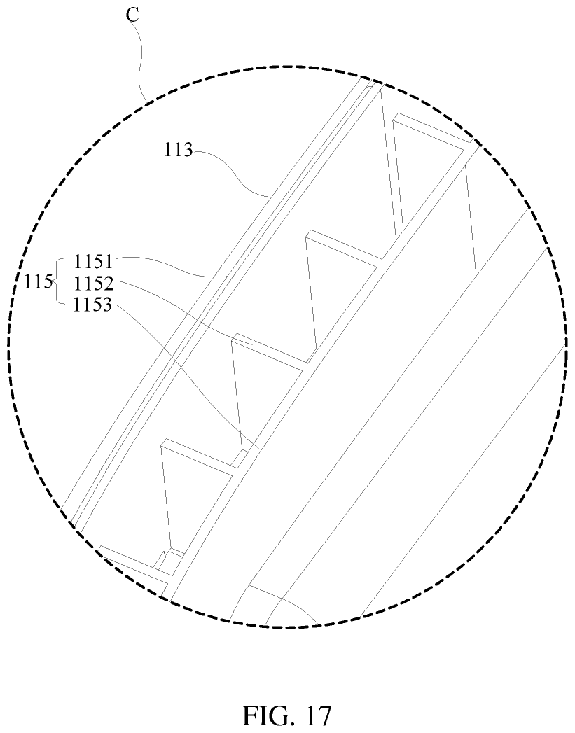

When the slow cooker is moved and placed or accidentally dropped, the lower shell 113 is usually a part colliding first, and the reinforcing structure 115 can increase a structural strength of an outer side of the lower shell 113, so that the falling resistance of the lower shell 113 can be greatly improved. With reference to FIG. 17, the reinforcing structure 115 is composed of the outer layer 1151, the reinforcing rib 1152 and the inner layer 1153, the reinforcing rib 1152 is arranged between the inner layer 1153 and the outer layer 1151, and the reinforcing rib 1152 has a sheet structure and is vertically arranged relative to the inner layer 1153 and the outer layer 1151. If the bottom portion of the slow cooker is severely impacted (such as dropping), the reinforcing rib 1152 may absorb the impact by generating deformation, thus reducing the impact on other parts of the slow cooker as far as possible. Meanwhile, a space is arranged between the inner layer 1153 and the outer layer 1151, and the reinforcing ribs 1152 may be annularly arranged in the space at even intervals, which is helpful to a heat preservation performance of the slow cooker while ensuring the structural strength.

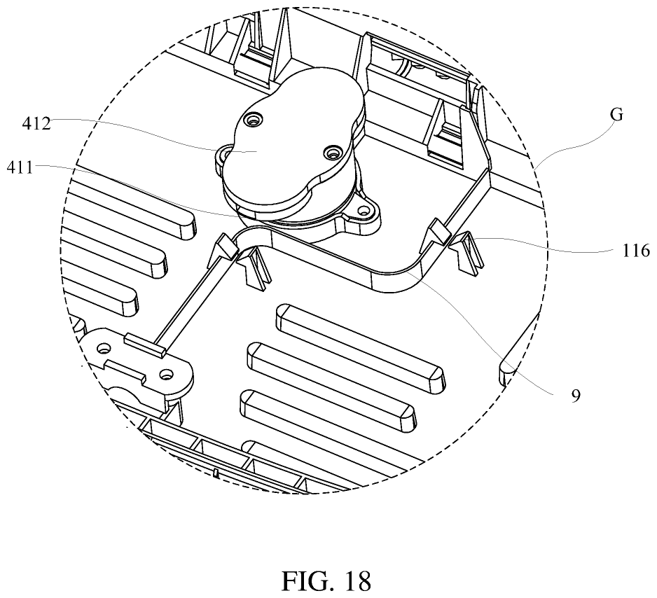

In one embodiment, with reference to FIG. 18, the lower shell 113 is further provided with a line clamping portion 116, the line clamping portion 116 is two claw buckles distributed in a mirror-image way, and one sides of free ends of the claw buckles close to each other are both provided with an inclined surface, and a power cord 9 is clamped between the two claw buckles through the free ends of the two claw buckles to fix the power cord 9, thus preventing the driving member 411 from being wound with the power cord 9 during rotation.

With reference to FIG. 14, the slow cooker further comprises a heat preservation sheet 8, and two opposite sides of the heat preservation sheet 8 respectively abut against an inner side surface of the body component 1 and an outer side surface of the inner container 2. The heat preservation sheet 8 surrounds the heating component 3 and the outer side surface of the inner container 2 to play a heat preservation and insulation role, which, on one hand, can improve the heating efficiency of the heating component 3, and play the heat preservation role for the inner container 2 to reduce a heat dissipation rate; and on the other hand, can hinder heat transfer to the cooker body 11, avoid the cooker body 11 from being damaged due to excessively high temperature, and prevent the user from being scalded due to excessively high temperature of the cooker body 11 at the same time. The heat preservation sheet 8 is made of a heat preservation and insulation material such as inorganic cotton.

The slow cooker comprises the cooker body 11, the cooker cover 12, the inner container 2, the heating component 3, the stirring component 4 and the limiting component 5, the cooker cover 12 is arranged on the cooker body 11, the assembly cavity S1 is formed inside the cooker body 11, and the cooker cover 12 comprises the perspective structure 122 arranged opposite to the assembly cavity S1; the heating component 3 is arranged between the inner container 2 and the cooker body 11, and the heating component 3 is used for providing heat energy to the inner container 2; the stirring component 4 comprises the power assembly 41 and the stirring member 42, the stirring member 42 is arranged in the accommodating cavity S2, and the power assembly 41 is used for driving the stirring member 42 to rotate; and the limiting space 51 is enclosed by the limiting component 5 and the inner container 2, the stirring member 42 is arranged in the limiting space 51, and the limiting space 51 is used for limiting the movement range of the stirring member 42. Compared with the prior art, the present application is provided with the perspective structure 122 and the limiting component 5, so that a user can directly observe a cooking state of food in the accommodating cavity S2 through the perspective structure 122 to determine whether it is necessary to stir the food or add spices, thus improving the use convenience of the device and achieving a better cooking effect; and the limiting space 51 limits the stirring member 42, and the movement range of the stirring member 42 is only limited in the limiting space 51, so that the stirring member 42 is avoided from being taken out when the food is taken out, thus solving the problem that it is difficult to separate the stirring member 42 and the food which are mixed.

In the description of the present invention, it should also be noted that the terms “arrangement”, “installation”, “connected” and “connection” should be understood in a broad sense unless otherwise clearly specified and defined. For example, they may be fixed connection, removable connection or integrated connection; may be mechanical connection or electrical connection; and may be direct connection indirect connection through an intermediate medium, and connection inside two elements. The specific meanings of the above terms in the present invention can be understood in a specific case by those of ordinary skills in the art.

It should be noted that relational terms herein, such as first, second, and the like, are used merely to distinguish one entity or operation from another entity or operation, and do not necessarily require or imply that there is any such relationship or order between these entities or operations. Furthermore, the terms “comprise”, “include”, or any other variation thereof, are intended to cover a non-exclusive inclusion, so that a process, a method, an article, or equipment that comprises a list of elements not only includes those elements but also includes other elements not expressly listed, or further includes elements inherent to such process, method, article, or equipment. In a case without further limitations, an element defined by the phrase “comprising one . . . ” does not preclude the presence of additional identical elements in the process, method, article, or equipment that includes the element.

Although the embodiments of the present invention have been shown and described, it is understood by those of ordinary skills in the art that various changes, modifications, substitutions and variations may be made to these embodiments without departing from the principle and spirit of the present invention, and the scope of the present invention is defined by the appended claims and their equivalents.

What is claimed is:

1. A slow cooker, comprising:
a body component (1), which comprises a cooker body (11) and a cooker cover (12), wherein the cooker cover (12) is arranged on the cooker body (11), an assembly cavity (S1) is formed inside the cooker body (11), and the cooker cover (12) comprises a perspective structure (122) arranged opposite to the assembly cavity (S1);
an inner container (2), which is connected with the cooker body (11) and located in the assembly cavity (S1), wherein an accommodating cavity (S2) is formed inside the inner container (2);
a heating component (3), which is arranged between the inner container (2) and the cooker body (11), wherein the heating component (3) is used for providing heat energy to the inner container (2);
a stirring component (4), which comprises a power assembly (41) and a stirring member (42), wherein the stirring member (42) is arranged in the accommodating cavity (S2), the power assembly (41) and the stirring member (42) are arranged on two opposite sides of the inner container (2) at interval, and the power assembly (41) is used for driving the stirring member (42) to rotate; and
a limiting component (5), wherein the limiting component (5) is connected to the inner container (2), a limiting space (51) is enclosed by the limiting component (5) and the inner container (2), the limiting component (5) is provided with a water outlet hole (52) communicated with the limiting space (51), the stirring member (42) is arranged in the limiting space (51), and the limiting space (51) is used for limiting a movement range of the stirring member (42).

2. The slow cooker according to claim 1, wherein the heating component (3) comprises a heating member (31) and an elastic member (32), the heating member (31) is attached to an outer side surface of the inner container (2), two ends of the elastic member (32) are elastically connected with two ends of the heating member (31) respectively, and the elastic member (32) tightens the two ends of the heating member (31) in a direction close to each other, so that the heating member (31) is tightly attached to the outer side surface of the inner container (2).

3. The slow cooker according to claim 2, wherein the heating component (3) further comprises a fixing sheet (33), the fixing sheet (33) is connected with the inner container (2), and the fixing sheet (33) makes the heating member (31) abut against the inner container (2).

4. The slow cooker according to claim 1, wherein the cooker cover (12) further comprises a cover body (121), a middle region of the cover body (121) is provided with a mounting space (1214), and the perspective structure (122) is arranged in the mounting space (1214); and the perspective structure (122) comprises a perspective portion (1221) and a connecting portion (1222) which are connected with each other, the connecting portion (1222) is arranged at an edge of the perspective portion (1221), the cover body (121) is provided with a connecting groove (1211), and the connecting portion (1222) is inserted into the connecting groove (1211), wherein a thickness of the connecting portion (1222) is greater than that of the perspective portion (1221), and the perspective portion (1221) and the cover body (121) are arranged at interval.

5. The slow cooker according to claim 4, wherein the cooker cover (12) further comprises a handle (123), a buffering member (124) and a fixing member (125), the perspective structure (122) is provided with at least one fixing hole (1223), the buffering member (124) penetrates through the fixing hole (1223) and is connected with the perspective structure (122), the handle (123) is connected with the buffering member (124), a through hole is formed inside the buffering member (124), and the fixing member (125) penetrates through the through hole and is connected with the handle (123).

6. The slow cooker according to claim 1, wherein the slow cooker further comprises a placing rack (6), the placing rack (6) is selectively placed in the accommodating cavity (S2), and the placing rack (6) is provided with a plurality of placing grooves (61) for placing food.

7. The slow cooker according to claim 1, wherein the cooker body (11) comprises an upper shell (111), a middle shell (112) and a lower shell (113) which are sequentially connected from top to bottom, the assembly cavity (S1) is enclosed by the upper shell (111), the middle shell (112) and the lower shell (113) jointly, an edge of an opening end of the inner container (2) is bent outwardly to form a bending portion, and the bending portion is connected with the upper shell (111).

8. The slow cooker according to claim 1, wherein the slow cooker further comprises a circuit component (7), the cooker body (11) comprises a lower shell (113) located at a bottom portion of the cooker body and a cover plate (114) detachably connected with the lower shell (113), at least a part of an outer surface of the lower shell (113) protrudes in a direction close to the inner container (2) to form a convex portion (1131), a mounting groove (1132) is formed inside the convex portion (1131), the circuit component (7) is arranged in the mounting groove (1132) and the circuit component and the convex portion (1131) are arranged at interval, the mounting groove (1132) is open towards the outside of the cooker body (11), and the cover plate (114) is covered at an opening end of the mounting groove (1132).

9. The slow cooker according to claim 8, wherein the cooker body (11) further comprises a reinforcing structure (115), the reinforcing structure (115) is annularly arranged on an inner side surface of the lower shell (113), and the reinforcing structure (115) comprises an outer layer (1151), a reinforcing rib (1152) and an inner layer (1153) in a direction from an edge of the lower shell (113) to a center of the lower shell, and the reinforcing ribs (1152) are respectively connected with the outer layer (1151) and the inner layer (1153).

10. The slow cooker according to claim 1, wherein the slow cooker further comprises a heat preservation sheet (8), and two opposite sides of the heat preservation sheet (8) respectively abut against an inner side surface of the body component (1) and an outer side surface of the inner container (2).
